(19) United States
(12) Patent Application Publication
(10) Pub. No.: US 2008/0240387 A1
(43) Pub. Date: Oct. 2, 2008

(54) Communication apparatus

(75) Inventor: Suzuyo Murai, Nagoya-shi (JP)

Correspondence Address: OLIFF & BERRIDGE, PLC, P.O. BOX 320850, ALEXANDRIA, VA, 22320-4850, US

(73) Assignee: BROTHER KOGYO KABUSHIKI KAISHA, NAGOYA-SHI (JP)

(21) Appl. No.: 12/076,826

(22) Filed: Mar. 24, 2008

(30) Foreign Application Priority Data
Mar. 27, 2007 (JP) 2007-082957

(51) Int. Cl. H04B 1/00

(52) U.S. Cl. 379/110.01

(57) ABSTRACT

A communication apparatus is provided. The communication apparatus comprises: a detection sensor for detecting a human body; a mode setting unit which sets a notification mode to a normal mode or a quiet mode; a sound notification unit which has a plurality of volume levels, and which conveys notification information by a sound; and a sound controller which controls the sound notification unit to convey the notification information at a volume according to the notification mode set by the mode setting unit and a result of the detection sensor.

### CROSS-REFERENCE TO RELATED APPLICATION

This application claims priority from Japanese Patent Application No. 2007-082957, filed on Mar. 27, 2007, the entire subject matter of which is incorporated herein by reference.

### TECHNICAL FIELD

Aspects of the present invention relate to a communication apparatus having a human body detection sensor that detects a human body.

### BACKGROUND

In related art communication apparatuses, which have a human body detection sensor that detects a human body, the communication apparatus stores sound pressure sample data of a predetermined value or vibration sample data of a predetermined value, and detects sound pressure near the apparatus or a vibration of the apparatus. Upon receiving a call notification, a detected sound pressure is compared with the stored sound pressure sample data, and a detected vibration is compared with the stored vibration sample data. If the detected sound pressure is lower than the stored sound pressure sample data and the detected vibration is less than the stored vibration sample data, it is determined that there are no persons nearby and a call tone is sounded with a call tone volume being gradually changed from a low state to a high state. Such a related art apparatus is described, for example, in JP-A-2006-325041.

However, the related art communication apparatus has a disadvantage in that the call tone volume becomes high even during nighttime, etc. Accordingly, the call tone often causes an annoyance to a person other than a user.

### SUMMARY

Exemplary embodiments of the present invention address the above disadvantages and other disadvantages not described above. However, the present invention is not required to overcome the disadvantages described above, and thus, an exemplary embodiment of the present invention may not overcome any of the problems described above.

Accordingly, it is an aspect of the present invention to provide a communication apparatus that prevents as much as possible, influence on persons other than a detected person during nighttime, etc., while still enabling the detected person to be notified reliably.

According to an exemplary embodiment of the present invention, there is provided a communication apparatus. The communication apparatus includes a detection sensor for detecting a human body; a mode setting unit which sets a notification mode to a normal mode or a quiet mode; a sound notification unit which has a plurality of volume levels, and which conveys notification information by a sound; and a sound controller which controls the sound notification unit to convey the notification information at a volume according to the notification mode set by the mode setting unit and a result of the detection sensor.

According to another exemplary embodiment of the present invention, there is provided a communication apparatus. The communication apparatus includes a detection sensor which detects a target; a mode setting unit which sets a notification mode to a normal mode or a quiet mode; a notification unit which conveys notification information; and a controller which controls the notification unit (i) to convey the notification information in a first state if the notification mode is set to the quiet mode and the detection sensor detects a target; or (ii) to convey the notification information in a second state if the notification mode is set to the normal mode, or if the notification mode is set to the quiet mode and the detection sensor does not detect a target.

### BRIEF DESCRIPTION OF THE DRAWINGS

The above and other aspects of the present invention will become more apparent and more readily appreciated from the following description of exemplary embodiments of the present invention taken in conjunction with the attached drawings, in which:

FIG. 1 is a perspective view of a general arrangement of a facsimile apparatus according to an exemplary embodiment of the present invention;

FIG. 2 is a block diagram of an electrical arrangement of the facsimile apparatus of FIG. 1;

FIG. 3 is a main flowchart of a notification process according to an exemplary embodiment of the present invention;

FIG. 4 is a sub-flowchart showing a quiet mode notification process of FIG. 3;

FIG. 5 is a sub-flowchart showing a message reproduction process of FIG. 4;

FIG. 6 is a diagram of an example of a display generated by the process of FIG. 5;

FIG. 7 is a diagram of an example of another display generated by the process of FIG. 5;

FIG. 8 is a diagram of an example of yet another display generated by the process of FIG. 5;

FIG. 9 is a sub-flowchart a back-home notification process of FIG. 4;

FIG. 10 is a diagram of an example of a display generated by the process of FIG. 9;

FIG. 11 is a diagram of an example of another display generated by the process of FIG. 9; and

FIG. 12 is a diagram of an example of yet another display generated by the process of FIG. 9

### DETAILED DESCRIPTION

Exemplary embodiments of the present invention shall now be described in detail with reference to the drawings. Exemplary embodiments relate to a communication apparatus, and may be more specifically embodied, for example, as a facsimile apparatus.

[Arrangement of a Communication Apparatus]

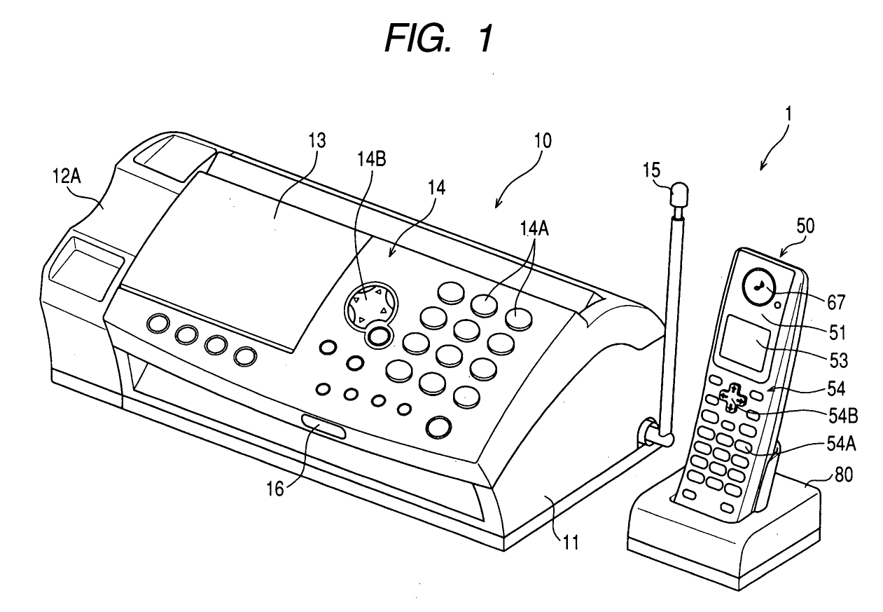

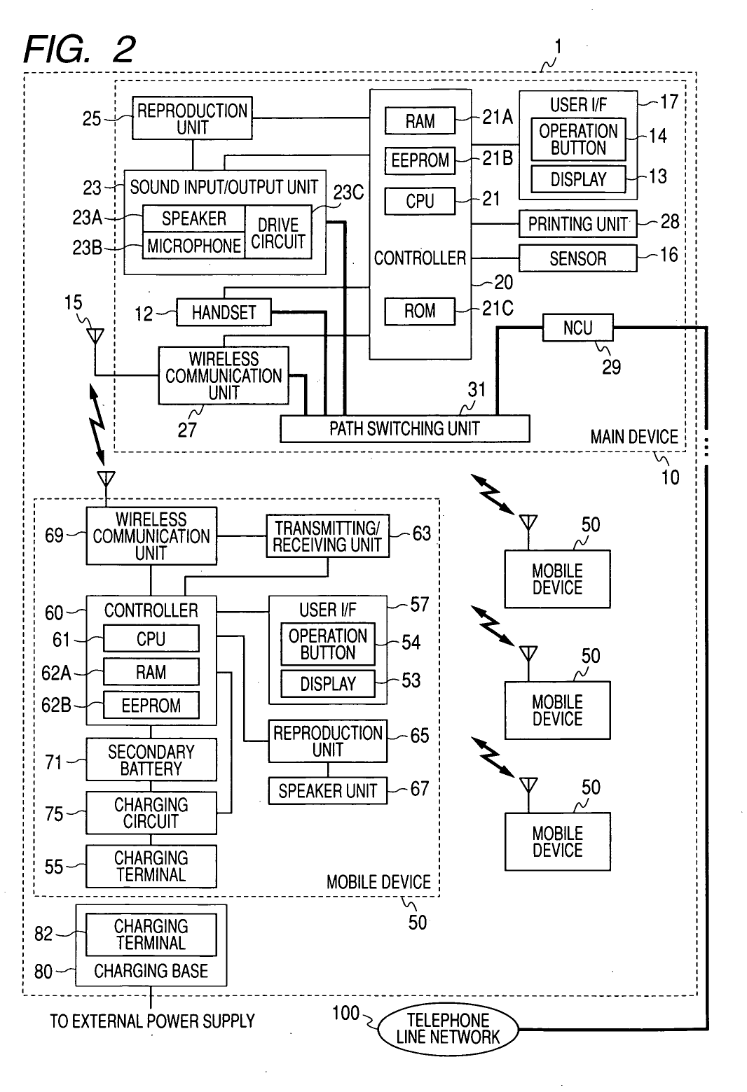

A general arrangement of a communication apparatus according to an exemplary embodiment of the present invention will now be described with reference to FIG. 1. FIG. 1 is a perspective view of a communication apparatus 1 (also referred to herein as a facsimile apparatus 1) according to an exemplary embodiment of the present invention. As shown in FIG. 1, the facsimile apparatus 1 has a function (telephone call function) of realizing sound communication via a telephone line network 100 (see FIG. 2), and a function (facsimile function) of sending and receiving image data via the telephone line network 100, etc. As shown in FIG. 1, the facsimile apparatus 1 comprises a main device 10, coupled to the telephone line network 100, a mobile device 50, coupled via a wireless line to the main device 10, and a charging base 80, coupled to an external power supply (not shown) and being for setting the mobile device 50 in a detachable manner and charging the set mobile device 50 at a predetermined voltage.

The main device 10 comprises a main device main unit case 11 comprising a receiver base 12A, on which is placed a handset 12 (not show) that is a transmitter and receiver used in a state of being removed from the main device 10. Furthermore, on an upper face of the main device main unit case 11 are disposed a liquid crystal display (LCD) 13, for displaying information related to various functions, and various operation buttons 14. The various operation buttons comprise dial buttons 14A, for input of a telephone number or a fax number of a party to be called, various commands, etc., and a select button 14B, operated to perform selection in a menu screen displayed on the LCD 13, etc.

The LCD 13 comprises a backlight that illuminates a display screen from a rear face. At a side face of the main device main unit case 11 at the side opposite the receiver base 12A is disposed an antenna 15 for performing wireless communication with the cordless mobile device 50. At a front face of the main device main unit case 11 is disposed a pyroelectric infrared sensor (hereinafter referred to as “pyroelectric sensor”) 16, which is an example of a human body detection sensor that detects a human body.

In addition to having the telephone (sound communication) function using the handset 12 placed on the receiver base 12A, the main device 10 has, as basic functions of a facsimile apparatus, a document reading function and an image recording function.

The mobile device 50 comprises a mobile device main unit case 51 with a handset shape. The mobile device 50 further comprises an LCD 53, for displaying information related to the various functions, various operation buttons 54 comprising dial buttons 54A, for input of a telephone number of a party to be called and a select button 54B, operated to perform selection in a menu screen displayed on the display panel 53, etc.. The mobile device 50 further comprises a speaker unit 67, outputting a tone signal, sounds of the called party, etc. The mobile device 50 also comprises a charging terminal 55 (see FIG. 2) for charging, from the charging base 80, a secondary battery 71 (see FIG. 2) that supplies power to the entirety of the mobile device 50.

The charging base 80 comprises a charging terminal 82 (see FIG. 2) that contacts the charging terminal 55 of the mobile device 50 when the mobile device 50 is set thereon. Because the mobile device 50 operates upon being supplied with power from the secondary battery 71 (see FIG. 2), when the secondary battery 71 is to be charged, the mobile device 50 is set on the charging base 80 as illustrated to perform charging. That is, when the mobile device 50 is set on the charging base 80, the mobile device 50 receives a supply of power from the charging base 80 and the secondary battery 71 is charged.

An electrical arrangement of the facsimile apparatus 1 shall now be described with reference to FIG. 2. FIG. 2 is a block diagram of the electrical arrangement of the facsimile apparatus 1 of FIG. 1. As shown in FIG. 2, the main device 10 comprises a controller 20, controlling operations of the entirety of the main device 10, the handset 12, and a user interface (hereinafter referred to as “user I/F”) 17. The user I/F 17 comprises the LCD 13 and the operation buttons 14, a sound input/output unit 23, inputting and outputting sound signals, a reproduction unit 25, reproducing sounds based on various sound signals stored in advance, a wireless communication unit 27, sending and receiving, by wireless communication, various signals, including sound signals, to and from the mobile device 50, a network control unit (NCU) 29, inputting and outputting sound signals or fax data transmitted via the telephone network line 100, a printing unit 28, configured to print a fax data via the telephone network line 100 on a recording medium, a path switching unit 31, switching a sound signal transmission path inside the main device 10, etc.

Among these, the controller 20 comprises a central processing unit (CPU) 21, performing overall control of the respective devices equipped in the main device 10, a random access memory (RAM) 21A, storing various data, an electronically erasable and programmable read only memory (EEPROM) 21B, enabled to store stored data even in a state in which power is not supplied, a read only memory (ROM) 21C, storing programs of various processes to be executed by the CPU 21, a timer (not shown), performing measurement of time, etc. The sound input and output unit 23 (hereinafter referred to as a sound input/output unit 23) comprises a speaker 23A, a microphone 23B, and a drive circuit 23C. The drive circuit 23C drives the speaker 23A and microphone 23B, and controls the speaker 23A to output sounds based on sound signals. The sound input/output unit 23 outputs sounds from the speaker 23A based on sound signals, and is arranged to enable so-called hands-free communication using the speaker 23A and the microphone 23B as a transmitter and a receiver.

The reproduction unit 25 stores sound signals, such as a call tone, used when an incoming call is received, a hold tone, used when sound communication is put on hold, etc., and reproduces a stored sound signal upon receiving an instruction from the CPU 21. The reproduced sound signal is output from the speaker 23A.

The wireless communication unit 27 sends and receives various signals, including sound signals, to and from the mobile device 50 via the antenna 15. If an operation for starting communication is performed, the path switching unit 31 switches the transmission path, used for input and output of sound signals with respect to the exterior of the main device 10, to a component among the handset 12, the sound input/output unit 23, and the wireless communication unit 27. Specifically, if the handset 12 is removed from the main device 10 main unit, the transmission path is switched to the handset 12; if an operation for starting hands-free communication is performed by an operation button 14 of the user I/F 17, the transmission path is switched to the sound input/output unit 23; and if an operation for starting communication by the mobile device 50 (for example, a communication setting operation by an operation button 54, to be described later, for performing an external line communication or an extension line communication with the main device 10 or another mobile device 50) is performed, the transmission path is switched to the wireless communication unit 27.

The mobile device 50 comprises a controller 60, controlling operations of the entirety of the mobile device 50; a transmitting and receiving unit 63 (hereinafter referred to as a transmitting/receiving unit 63), which comprises a speaker, a microphone, and a drive circuit for driving the speaker and the microphone; a user I/F 57, which comprises the LCD 53 and the operation buttons 54; a reproduction unit 65, reproducing sounds based on various sound signals stored in advance; a speaker unit 67, comprising a speaker and outputting sounds reproduced by the reproduction unit 65, and a drive circuit, driving the speaker; a wireless communication unit 69, sending and receiving, by wireless communication, various signals, including sound signals, to and from the wireless communication unit 27 of the main device 10; the secondary battery 71, supplying power to the entirety of the mobile device 50; the charging terminal 55, electrically coupled to the charging terminal 82 of the charging base 80; and a charging circuit 75, detecting application of voltage to the charging terminal 55 and charging the secondary battery 71 by a power supply voltage supplied from the charging base 80 via the charging terminal 55.

The controller 60 comprises a CPU 61, performing overall control of the respective devices equipped in the mobile device 50, a RAM 62A, storing various data, and an EEPROM 62B, enabled to store stored data even in a state in which power is not supplied. The reproduction unit 65 stores sound signals, such as the call tone, used when an incoming call is received, the hold tone, used when sound communication is put on hold, etc.

Furthermore, the charging base 80 has the charging terminal 82 and is connected to the external power supply (of, for example, about 100V AC). With the facsimile apparatus 1 arranged as described above, the main device 10 is enabled to perform external line communication with another external communication terminal through the telephone line network 100 and perform extension line communication with the mobile device 50. The mobile device 50 is enabled to perform external line communication with another external communication terminal through the telephone line network 100 via the main device 10.

Mobile devices 50 can be installed additionally up to a maximum of four units, and if a plurality of mobile devices 50 are present, extension line communication among mobile devices 50 is enabled. Presenting this exemplary embodiment, if extension line communication among mobile devices 50 is to be performed, each mobile device 50 performs communication with the main device 10 and the mobile devices 50 perform the extension line communication with each other via the main device 10.

[Notification Process]

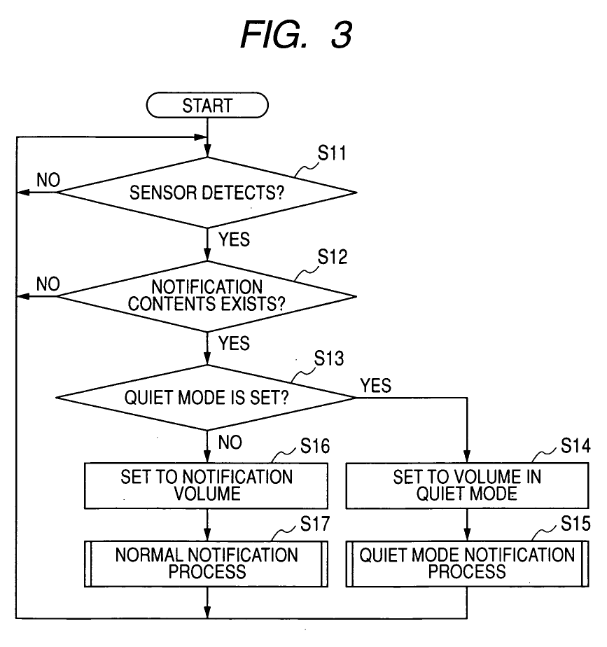

A notification process shall now be described based on FIG. 3.

FIG. 3 is a flowchart of the notification process according to an exemplary embodiment of the present invention.

As shown in FIG. 3, at an operation S11, it is determined whether the sensor detects anything. More specifically, the CPU 21 waits for a person to become present near the main device 10 and across the pyroelectric sensor 16, that is for example, the CPU 21 waits for a user to come home (S11: NO).

If it is determined that a person is detected near the main device 10 by the pyroelectric sensor, that is for example, if the user who came home is detected (S11: YES), execution proceeds with operation S12. At operation S12, it is determined if any notification content exists. More specifically, the CPU 21 executes a determination process of determining whether a message to be transmitted to the detected person is stored in the RAM 21A or a dial number of another party to whom a predetermined message is to be transmitted is stored in the EEPROM 21B.

If it is determined that a message to be transmitted to the detected person is not stored in the RAM 21A or a dial number of another party to whom a predetermined message is to be transmitted is not stored in the EEPROM 21B (S12: NO), execution returns to operation S11. On the other hand, if it is determined that a message to be transmitted to the detected person is stored in the RAM 21A or a dial number of another party to whom a predetermined message is to be transmitted is stored in the EEPROM 21B (S12: YES), execution proceeds to operation S13. At operation S13, it is determined if quiet mode has been set. More specifically, the CPU 21 executes a determination process of determining whether a quiet mode is set, that is, whether a present time is a time between a start time and an end time of the quiet mode.

The “quiet mode” denotes a mode, in which, from a start time to an end time, during for example bedtime, that have been set in advance by means of the operation buttons 14 (for example, from 11:00 PM to 7:00 AM), a function, of performing message reproduction (line monitoring) or other form of output of a call tone for an external line call or output of contents recorded in a message recording, etc., from the speaker 23A or the speaker unit 67, is stopped at both the main device 10 and the mobile device 50. If the quiet mode is set, unless cancellation of the quiet mode is performed, the quiet mode is automatically set repeatedly from the start time to the end time set in advance (for example, from 11:00 PM to 7:00 AM). The CPU 21 stores the set start time and end time of the quiet mode in the EEPROM 21B.

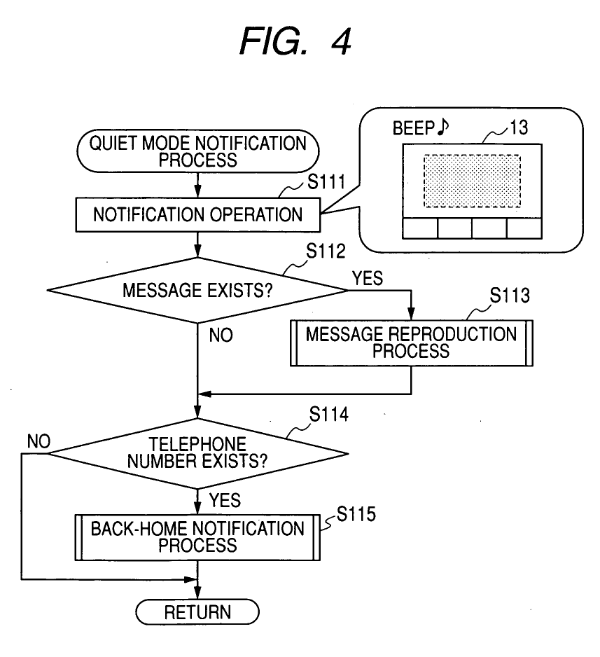

Returning to FIG. 3, if it is determined that the quiet mode is set, that is, if the present time is a time between the start time and the end time of the quiet mode (S13: YES), execution proceeds to operation S14. At operation S14, a volume level is set to quiet mode. More specifically, the CPU 21 sets, via the sound input/output unit 23, a volume of the speaker 23A to a volume in the quiet mode, that is, to a volume of a “minimum” level. At operation S15, a quiet mode notification process is executed. More specifically, the CPU 21 executes a sub-process of a “quiet mode notification process” to be described later (see FIG. 4), and thereafter execution returns to operation S11.

The volume of the speaker 23A may be selectable among one of four levels: “minimum,” “low,” “medium,” and “high.” The “minimum” level is lower than the “low” level, which is lower than the “medium” level which is lower that the “high” level. The “high level” denotes a maximum possible volume output from the speaker. For example, the “minimum” level volume enables hearing close to the main device 10. The “high” level volume enables hearing approximately 3 m to 10 m away from the main device 10 in a quiet room.

On the other hand, if it is determined that the quiet mode is not set (herein, if the quiet mode is not set, it is assumed that a normal mode is set), that is, if the present time is a time before the start time or after the end time of the quiet mode (S13: NO), execution proceeds with operation S16. At operation S16, the notification volume is set. More specifically, the CPU 21 sets, via the sound input/output unit 23, the volume of the speaker 23A to a normal volume (for example, the “medium” level volume) that has been set in advance.

At operation S17, a normal notification process is executed, and the process returns to operation S11. More specifically, the CPU 21 executes a sub process of a “normal notification process,” and thereafter executes the processes from operation S11 again. For example, the CPU 21 reproduces a transmission message, stored in the RAM 21A at the “medium” level volume via the speaker 23A. Or if a dial number of another party to whom a predetermined message is to be transmitted is stored in the EEPROM 21B, the CPU 21 reproduces a dial send tone at the “medium” level volume while the dial number of the other party is being dialed. Also, during transmission of the predetermined message, the CPU 21 performs reproduction (line monitoring) of the predetermined message by the speaker 23A at the “medium” level volume and thereafter disconnects the line.

[Quiet Mode Notification Process]

A sub-process of the quiet mode notification process shall now be described based on FIG. 4. FIG. 4 is a sub-flowchart showing a quiet mode notification process of FIG. 3. As shown in FIG. 4, at operation S111, a notification operation is executed. More specifically, the CPU 21 issues, via the speaker 23A, a “beep” or other alert tone at the “minimum” level volume, set at operation S14, and lights up the backlight of the LCD 13 to call the attention of the person detected by the pyroelectric sensor 16 and notify that there are notification contents.

If a message to be transmitted to the person detected by the pyroelectric sensor 16 is stored in the RAM 21A, the CPU 21 may perform sound guidance, such as audibly reciting “There is a message,” etc., at the “minimum” level volume. Or the backlight of the liquid crystal display 13 may be lit in a blinking manner for a predetermined time (for example, about 5 to about 10 seconds).

At operation S112, it is determined if a message exists. More specifically, the CPU 21 executes a determination process of determining whether a message to be transmitted to the person detected by the pyroelectric sensor 16 is stored in the RAM 21A.

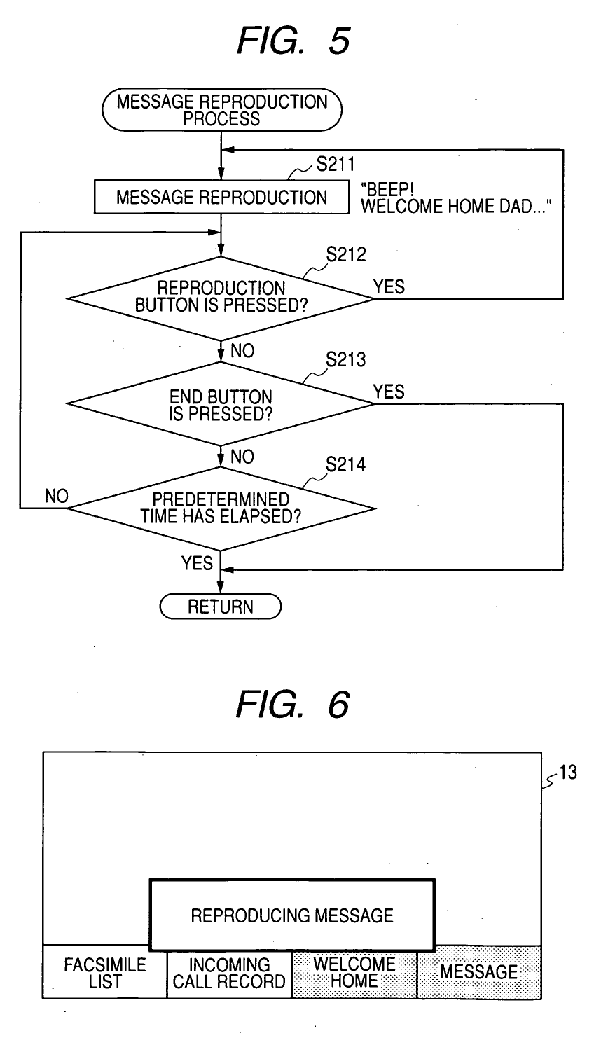

If it is determined that a message to be transmitted to the person detected by the pyroelectric sensor 16 is stored in the RAM 21A (S112: YES), execution proceeds to operation S113. At operation S113, a message reproduction process is performed. More specifically, the CPU 21 executes a sub-process of a message reproduction process to be described later (see FIG. 5) and thereafter execution proceeds to operation S114.

On the other hand, if it is determined that a message to be transmitted to the person detected by the pyroelectric sensor 16 is not stored in the RAM 21A (S112: NO), the process continues at operation S114. At S114, it is determined if a telephone number exists. More specifically, the CPU 21 executes a determination process of determining whether a dial number of another party to whom a predetermined message is to be transmitted is stored in the EEPROM 21B. If it is determined that a dial number of another party to whom a predetermined message is to be transmitted is not stored in the EEPROM 21B (S114: NO), the sub-process ends and execution returns to operation S11.

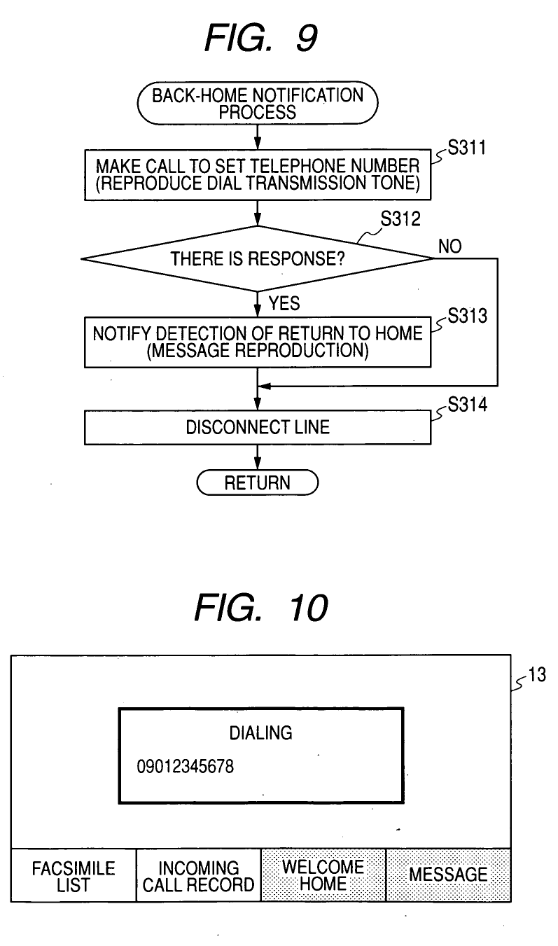

On the other hand, if it is determined that a dial number of another party to whom a predetermined message is to be transmitted is stored in the EEPROM 21B (S114: YES), execution proceeds with operation S115. At operation S115, a back-home notification process is executed. More specifically, the CPU 21 executes a sub-process of a back-home notification process to be described later (see FIG. 9), and thereafter the sub-process ends and execution returns to operation S11.

[Message Reproduction Process]

The sub-process of the “message reproduction process” shall now be described with reference to FIGS. 5 to 8.

FIG. 5 shows a sub-flowchart of the message reproduction process of FIG. 4.

As shown in FIG. 5, at operation S211, a message reproduction is performed. More specifically, the CPU 21 first performs, via the speaker 23A and at the “minimum” level volume set at operation S14, the sounding of the “beep” or other alert tone and thereafter the reading and reproduction of the message to be transmitted to the detected person from the RAM 21A.

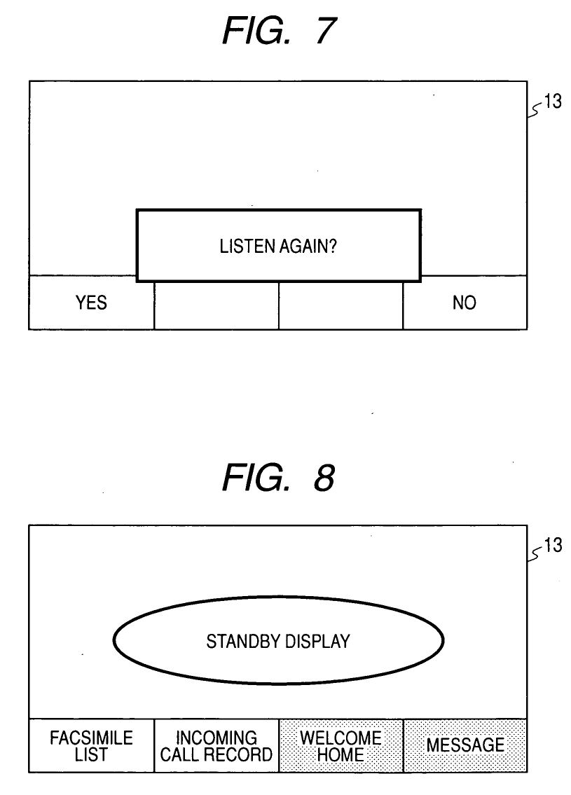

For example, as shown in FIG. 6, the CPU 21 controls the display to display a reproduction message such as, for example, “Message being reproduced”, on the LCD 13. Also, the CPU 21 performs, via the speaker 23A and at the “minimum” level volume, the sounding of the “beep” and thereafter reproducing the message, for example: “Welcome home Dad . . . ” Thereafter, as shown in FIG. 7, a query is displayed, such as for example, “Listen again?”, on the LCD 13, and answer prompts are displayed, such as “Yes” displayed at a lower left corner and “No” displayed at a lower right corner of the LCD 13.

The person (for example, a father) who is detected close to the main device 10 is thereby enabled to hear the alert tone and the message reproduced at the “minimum” level volume even upon coming home late at night. Because the alert tone and the message reproduction sound are of the “minimum” level volume enabling hearing close to the main device 10 but cannot be heard by family members sleeping in a bedroom, etc., the family members can be prevented from being disturbed in their sound sleep or annoyed otherwise.

At operation S212, it is determined whether a reproduction button is pressed. More specifically, the CPU 21 executes a determination process of determining whether a reproduction button, which, among the operation buttons 14, instructs reproduction of a message, is pressed. For example, as shown in FIGS. 1 and 7, a button at a left end at a front side of the LCD 13 is the “reproduction button” in this exemplary embodiment. However, the reproduction button may be located anywhere on the main unit 10 or the mobile device 50, or wherever it would be easily accessible by a user. If it is determined that the reproduction button is pressed (S212: YES), execution proceeds back to operation S211. On the other hand, if it is determined that the reproduction button is not pressed (S212: NO), execution proceeds to operation S213. At operation S213, it is determined whether an end button is pressed. More specifically, the CPU 21 executes a determination process of determining whether an end button, which, among the operation buttons, instructs ending of message reproduction, is pressed. For example, as shown in FIGS. 1 and 7, a button at a right end at the front side of the LCD 13 is the “end button” in this exemplary embodiment. However, the end button may be located anywhere which would be conveniently accessible to a user.

If it is determined that the end button is pressed (S213: YES), the present sub-process ends and execution returns to the quiet mode notification process described above. Also, for example, as shown in FIG. 8, the CPU 21 may control the LCD 13 to display a standby display on the LCD 13. On the other hand, if it is determined that the end button is not pressed (S213: NO), execution continues to operation S214. At operation S214, it is determined whether a threshold time has elapsed. More specifically, the CPU 21 executes a determination process of determining whether a threshold time (for example, approximately 3 minutes) has elapsed since the reproduction of the message.

If it is determined that the threshold time has not elapsed since the message reproduction (S214: NO), execution proceeds back to operation S212. On the other hand, if it is determined that the threshold time has elapsed since the message reproduction (S214: YES), the sub-process ends and execution returns to the quiet mode notification process. Also, for example, as shown in FIG. 8, the CPU 21 may control the LCD 13 to display a standby display on the LCD 13.

[Back-Home Notification Process]

The sub-process of the back-home notification process shall now be described with reference to FIGS. 9 to 12. FIG. 9 is a sub-flowchart of the back-home notification process of FIG. 4.

As shown in FIG. 9, at operation S311, a call is made to the telephone number previously set. More specifically, the CPU 21 reads, from the EEPROM 21B, a dial number of another party to whom a predetermined message is to be transmitted once a person is back home, and makes a call to the dial number. The CPU 21 reproduces a dial transmission tone at the “minimum” level volume set at operation S14. Also, for example, as shown in FIG. 10, the CPU 21 controls the LCD 13 to display a message, such as for example “Dialing”, along with the dial number, for example, “09012345678” on the LCD 13.

The person (for example, the father) detected close to the main device 10 can thereby recognize, upon returning home, for example, late at night, that the main device 10 is making a telephone call, to the designated party, notifying the designated party that the person has returned home. Because the dial transmission tone is of a volume which can be heard close to the main device 10 but cannot be heard by family members in another room, for example sleeping in a bedroom, etc., the family members can be prevented from being disturbed.

At operation S312, it is determined whether there is a response to the call. More specifically, the CPU 21 executes a determination process of determining whether the designated party responded, that is, whether a state enabling external line communication with the designated party's telephone apparatus is entered. If it is determined that the designated party has not responded (S212: NO), execution continued with operation S314.

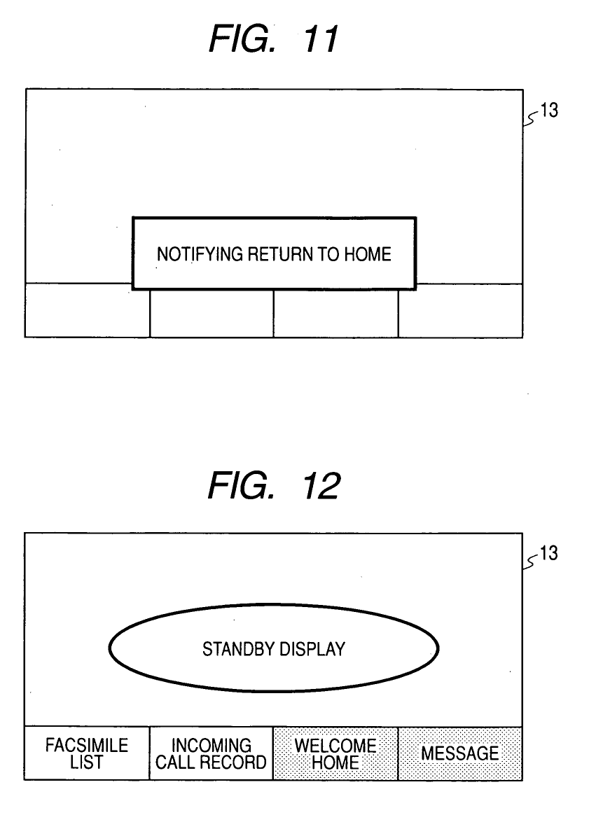

On the other hand, if it is determined that the designated party has responded and a state enabling external line communication with the designated party's telephone apparatus is entered (S312: YES), execution proceeds to operation S313. At operation S313, a message is transmitted to the designated party and the person is notified of the transmission. More specifically, the CPU 21 reads a predetermined message, which notifies that the person has returned home and has been registered in advance in the ROM 21C, and transmits the message to the designated party's telephone apparatus. At the same time, the CPU 21 reproduces the predetermined message via the speaker 23A at the “minimum” level volume set at operation S14. Also, for example, as shown in FIG. 11, the CPU 21 controls the LCD 13 to display a message such as, for example, “Notifying return to home”, on the LCD 13.

The person (for example, the father returning home) detected close to the main device 10 can thereby recognize the message that the main device 10 is transmitting to the designated party's telephone apparatus. Because the message reproduction sound is of a volume which may be heard close to the main device 10 but cannot be heard by family members in another room, for example sleeping in a bedroom, etc., the family members can be prevented from being disturbed or otherwise annoyed.

At operation S314, the line is disconnected. More specifically, the CPU 21 disconnects the line, ends the present sub-process, and execution returns to the quiet mode notification process. Also, for example, as shown in FIG. 12, the CPU 21 displays a standby message on the LCD 13.

### Effects of Exemplary Embodiment

As described in detail above, with the facsimile apparatus 1 according to an exemplary embodiment of the present invention, if the quiet mode is set and a person is detected near the main device 10 by the pyroelectric sensor 16, the CPU 21 of the main device 10 reproduces a message, a dial transmission tone, etc., at a volume of a “minimum” level, which, is the lowest level among the four settable stages of volume. Thus, this “minimum” level enables hearing close to the main device 10 (S111 to S115).

Because it is possible to recognize in advance that, when the quiet mode is set, the volume of the speaker 23A is set to the “minimum” level volume, it is possible to listen carefully to the message, etc., notified by the main device 10, at a location close to the main unit. At the same time, because the message or the dial transmission tone is of the volume which enables hearing close to the main device 10 but not far away from the device, such as by family members in another room, i.e., sleeping in a bedroom, etc., the family members can be prevented from being disturbed or otherwise from being annoyed.

Also, if the quiet mode is set and a person is detected near the main device 10 by the pyroelectric sensor 16, the CPU 21 of the main device 10 sounds a “beep” or other alert tone at the “minimum” level volume and lights up the backlight of the liquid crystal display 13 (S111). The CPU 21 can thereby call the attention of the person detected by the pyroelectric sensor 16 and reliably notify that there are notification contents. Also, even if the user misses hearing the alert tone, etc., that is reproduced at the “minimum” level volume, because the backlight of the liquid crystal display 13 becomes lit, the user can rehear the message reproduced at the “minimum” level volume.

Also, in reproducing a message, etc., if the quiet mode is set and a person is detected near the main device 10 by the pyroelectric sensor 16, the CPU 21 of the main device 10 displays a message, such as “Message being reproduced”, on the LCD 13 (S211). The detected person can thus readily recognize, by the message displayed on the liquid crystal display 13, that a message is being reproduced at the “minimum” level volume by the speaker 23A. Also, even if the user misses hearing the message reproduced at the “minimum” level volume, the user is enabled to rehear the message.

Also, in reproducing a message, etc., if the quiet mode is set and a person is detected near the main device 10 by the pyroelectric sensor 16, the CPU 21 of the main device 10 first sounds a “beep” or other alert tone and then reproduces the message, etc. (S211). The detected person can thus readily recognize, by hearing the alert tone, that there is a message, etc., to be reproduced. The detected person may then listen carefully to the message being reproduced at the “minimum” level volume and can hear the transmitted matter, etc., reliably. Furthermore, because the pyroelectric sensor 16 is a pyroelectric infrared sensor, a person approaching near the main device 10 can be detected reliably.

The present inventive concept is not restricted to the exemplary embodiment described above and, various modifications may be made within the scope of the present inventive concept. For example, the following arrangements are possible.

(A) If a facsimile message of image data, etc., is received when the quiet mode is set, the CPU 21 of the main device 10 may perform silent reception and store the facsimile message in the RAM 21A without printing it. The facsimile message may be printed after the quiet mode is ended. Disturbance a person and other annoyance due to printing sounds can thereby be prevented.

(B) If there is an incoming call from an external line when the quiet mode is set, a message may be recorded and message reproduction (line monitoring) by the speaker 23A may be disabled during the message recording.

(C) If an alarm function is equipped, the CPU 21 may reproduce an alarm sound upon setting the volume of the speaker 23A to “high” when the alarm set time arrives, even if the quiet mode is set. A user is thereby enabled to use the alarm function even during the time in which the quiet mode is set.

(D) If an extension call command from the CPU 61 of the mobile deice 50 is received when the quiet mode is set, the CPU 21 of the main device 10 may reproduce, via the speaker 23A, a call tone at the “minimum” level volume enabling a person close to the main device 10 to hear the call tone. Another person who is farther away can thereby be prevented from being disturbed or annoyed, and the person close to the main device 10 can respond appropriately to the call from the mobile device 50.

(E) In the above-exemplary embodiment, in the quiet mode, the volume level of the speaker 23A is set to the “minimum” level”, which is the lowest volume level of the speaker 23A. However, the present invention is not limited there to. If the normal volume, which is set at operation S16 is “medium level”, the volume may be set to the “low” level or “minimum” level, which is lower than the “medium” level, in the quiet mode. That is, in the quiet mode, the volume level of the speaker 23A is set lower than the volume level of the speaker 23A in the mode other than the quiet mode (normal mode).

What is claimed is:

1. A communication apparatus comprising:
a detection sensor for detecting a human body;
a mode setting unit which sets a notification mode to a normal mode or a quiet mode;
a sound notification unit which has a plurality of volume levels, and which conveys notification information by a sound; and
a sound controller which controls the sound notification unit to convey the notification information at a volume according to the notification mode set by the mode setting unit and a result of the detection sensor.

2. The communication apparatus according to claim 1,
wherein the sound controller controls the sound notification unit to convey the notification information at a lowest volume level of the plurality of volume levels of the sound notification unit, if the notification mode is set to the quiet mode and the detection sensor detects a human body.

3. The communication apparatus according to claim 2,
wherein the lowest volume level is capable of being heard at a position close to the communication apparatus.

4. The communication apparatus according to claim 1,
wherein the sound controller controls the sound notification unit to convey the notification information at a first volume level of the plurality of volume levels of the sound notification unit, if the notification mode is set to the normal mode,
wherein the sound controller controls the sound notification unit to convey the notification information at a second volume level of the plurality of volume levels of the sound notification unit if the notification mode is set to the quiet mode and the detection sensor detects a human body, and
wherein the first volume level is higher than the second volume level.

5. The communication apparatus according to claim 1, further comprising:
a light notification unit which is configured to emit light; and
a light emission controller which controls the light notification unit to emit the light if the notification mode is set to the quiet mode and the detection sensor detects a human body.

6. The communication apparatus according to claim 1, further comprising:
a display unit; and
a display controller which controls the display unit to display a message if the notification mode is set to the quiet mode and the detection unit detects a human body.

7. The communication apparatus according to claim 1,
wherein if the notification information comprises a message, the sound controller controls the sound notification unit to convey the message after outputting an alert tone.

8. The communication apparatus according to claim 1, further comprising:
an additional device; and
an incoming call detection unit which detects an incoming call from the additional device,
wherein, if the notification mode is set to the quiet mode and the incoming call detection unit detects an incoming call from the additional device, the sound controller controls the sound notification unit to output a call tone at a lowest volume level of the plurality of volume levels of the sound notification unit.

9. The communication apparatus according to claim 1, further comprising:
an additional device; and
an incoming call detection unit which detects an incoming call from the additional device,
wherein, if the notification mode is set to the normal mode and the incoming call detection unit detects an incoming call from the additional device, the sound controller controls the sound notification unit to output a call tone at a first volume level of the plurality of volume levels of the sound notification unit, and
wherein, if the notification mode is set to the quiet mode and the incoming call detection unit detects an incoming call from the additional device, the sound controller controls the sound notification unit to output a call tone at a second volume level of the plurality of volume levels of the sound notification unit, and
wherein the first volume level is higher than the second volume level.

10. The communication apparatus according to claim 1, further comprising a volume setting unit which sets a volume level of the notification unit among a plurality of volume levels,
wherein the sound controller controls the sound notification unit to convey the notification information at a lowest volume level that can be set by the volume setting unit, if the notification mode is set to the quiet mode and the detection sensor detects a human body.

11. The communication apparatus according to claim 1,
wherein the detection sensor comprises a pyroelectric infrared sensor.

12. A communication apparatus comprising:
a detection sensor which detects a target;
a mode setting unit which sets a notification mode to a normal mode or a quiet mode;
a notification unit which conveys notification information; and
a controller which controls the notification unit
(i) to convey the notification information in a first state if the notification mode is set to the quiet mode and the detection sensor detects a target; or
(ii) to convey the notification information in a second state if the notification mode is set to the normal mode, or if the notification mode is set to the quiet mode and the detection sensor does not detect a target.

13. The communication apparatus according to claim 12, further comprising a communication unit which receives the notification information through a telephone line network.

14. The communication apparatus according to claim 12,
wherein the target comprises a human body.

15. The communication apparatus according to claim 12,
wherein the notification mode is set to the quiet mode from a first time to a second time in a day.

16. The communication apparatus according to claim 12,
wherein the notification unit comprises a printing unit which prints the notification information, and
wherein the controller controls the printing unit to prevent printing of the notification information if the notification mode is set to the quiet mode.
